(19) United States
(12) Patent Application Publication
(10) Pub. No.: US 2024/0384071 A1
(43) Pub. Date: Nov. 21, 2024

(54) RESIN COMPOSITION FOR HEAT-DISSIPATING GAP FILLER, HEAT-DISSIPATING GAP FILLER, AND ARTICLE

(71) Applicant: TOKYO PRINTING INK MFG. CO., LTD., Tokyo (JP)

(72) Inventors: Katsuhiko HAYASHI, Saitama-shi, Saitama (JP); Junki TAKAI, Saitama-shi, Saitama (JP)

(21) Appl. No.: 18/693,801

(22) PCT Filed: Sep. 29, 2022
(86) PCT No.: PCT/JP2022/036404

§ 371 Date: Mar. 20, 2024

(30) Foreign Application Priority Data
Oct. 4, 2021 (JP) 2021-163412
Apr. 26, 2022 (JP) 2022-072233

(51) Int. Cl. C08L 9/00; C09K 5/14

(52) U.S. Cl. CPC C08L 9/00; C09K 5/14; C08L 2205/02

(57) ABSTRACT

A resin composition for a heat-dissipating gap filler includes a maleic anhydride-modified polybutadiene, a hydroxyl group-modified polybutadiene, a thermally conductive filler, and an antioxidant, in which a content of the antioxidant is 0.01% by mass or more when a total amount of the resin composition for a heat-dissipating gap filler is 100% by mass, and a thermal conductance of the resin composition for a heat-dissipating gap filler after curing is 1.0 W/m·K or more.

### TECHNICAL FIELD

The present invention relates to a resin composition for a heat-dissipating gap filler, a heat-dissipating gap filler, and an article.

### BACKGROUND ART

In recent years, heat generation from electronic devices such as digital home appliances, lithium-ion secondary batteries, and vehicle-mounted power modules has continued to increase along with higher capacities and greater functionality. On the other hand, with the object of making these electronic devices smaller, lighter, and thinner, the metal constituent members thereof are increasingly being replaced with resins. Since resins generally have lower thermal conductivity than metals, it is important to efficiently dissipate heat from the constituent members of these electronic devices in order to suppress heat increases therein.

Therefore, as a method for efficiently dissipating heat, methods using a highly thermally conductive filler or adhesive between the constituent members are known. This type of filler or adhesive is called a gap filler and is generally a material that contains a metal oxide having high thermal conductance in a resin component; however, the gap filler has the advantage of being liquid and therefore being applicable to complex shapes and able to be automatically dispensed using a coating device called a dispenser.

In the related art, silicone and polyurethane have been used as the resin component of such gap fillers.

Although silicone may have elastomeric properties suitable for this application, when used in the vicinity of electrical contacts such as battery cells, contact failures may occur due to the volatile silicone included therein, the low molecular weight siloxane generated therefrom, and the like. In addition, for the above, water may be added due to a moisture curing type reaction and the generation of voids due to water leads to a decrease in thermal conductance. In addition, problems of volumetric shrinkage due to the evaporation of volatile silicones, low-molecular-weight siloxanes, and water and problems of decreased storage stability due to separation of water from the liquid before curing have also been pointed out.

In addition, polyurethane may also exhibit excellent elastomeric characteristics, but the raw material thereof, isocyanate, not only poses toxicity concerns, but also reacts with water to form carbon dioxide voids. Accordingly, in order to not generate voids that impede thermal conductivity, it is necessary to carry out the curing reaction in a state in which no water is present. On the other hand, heat-dissipating gap fillers need to contain high concentrations of inorganic fillers having a high surface area (small particle size), but it is not possible to avoid moisture adsorption with this type of inorganic filler during normal handling, thus, extensive and therefore expensive drying steps and handling are required.

Therefore, various studies have been conducted on heat-dissipating gap fillers using resins other than silicone or polyurethane.

For example, Patent Document 1 discloses “an epoxy resin composition for two liquid-type casting including a main agent component including a liquid epoxy resin (A), an inorganic filler (B), a phosphoric ester-based wet dispersing agent (C), and a urea-based compound (D), and a curing agent component including a curing agent (E) and a curing accelerator (F), in which a content of the phosphoric ester-based wet dispersing agent (C) with respect to 100 parts by mass of the liquid epoxy resin (A) is 0.1 to 5 parts by mass and a ratio ((C)/(D)) between the phosphoric ester-based wet dispersing agent (C) and the urea-based compound (D) is 0.1/1 to 1.5/1.” and indicates that it is possible to “provide an epoxy resin composition for two liquid-type casting that does not easily precipitate a filler, that maintains high-thermal conductivity and electrical insulation properties in a cured product, and that has excellent mechanical strength; and an electronic component formed by casting the epoxy resin composition”.

In addition, Patent Document 2 discloses “a two liquid-type curable composition which is cured to form a thermally conductive cured product, the composition including a first portion including (i) at least one type of polymerizable (meth)acrylate-based monomer component, (ii) a peroxide-based curing agent component, (iii) one or more co-curative components selected from a group consisting of primary, secondary, or tertiary amines or compounds including the group —CONHNH—, (iv) a stabilizing component, and (v) a filler component; and a second portion including (i) at least one type of a polymerizable (meth)acrylate-based monomer component, (ii) a catalytic component for catalyzing the curing reaction, (iii) a stabilizing component, and (iv) a thermally conductive filler component, in which at least one portion of the composition has a filler component including a thermally conductive filler” and the composition disclosed in Patent Document 2 has been described as being useful for bonding heat-generating components, such as electrical components, to substrates, such as heat sinks.

Furthermore, Patent Document 3 discloses a thermally conductive gap filler including an aziridino-functional polyether polymer and at least 30% by volume of a thermally conductive filler based on the total volume of the gap filler and the thermally conductive gap filler of Patent Document 3 is described as suitable for use in electronic applications such as battery assemblies.

Patent Document 4, which was published recently, discloses a curable composition, the composition including a polyol component including one or more polyols, a functional butadiene component, and a thermally conductive filler present in an amount of at least 20% by weight based on the total weight of the curable composition, in which the curable composition has a thermal conductance of at least 0.5 W/(mK) after curing, and the curable composition of Patent Document 4 may be used, for example, as a thermally conductive gap filler, which is described as suitable for use in electronic technological applications such as battery assemblies.

### RELATED DOCUMENT

### Patent Document

[Patent Document 1] Japanese Unexamined Patent Application, First Publication No. 2016-60826
[Patent Document 2] Published Japanese Translation No. 2007-528437 of the PCT International Publication
[Patent Document 3] Published Japanese Translation No. 2020-511732 of the PCT International Publication
[Patent Document 4] Published Japanese Translation No. 2022-507500 of the PCT International Publication

### SUMMARY OF THE INVENTION

### Technical Problem

However, the epoxy-based material of Patent Document 1 requires curing at a high temperature, at least in a case where the curing agent is an acid anhydride as described in the Examples, since curing at room temperature takes a long time. In addition, in general, there are many liquid epoxy compounds for which there are concerns regarding mutagenicity. It is not possible for the acrylic-based material of Patent Document 2 to be stored at a temperature higher than the decomposition temperature of peroxide, which is a curing agent, and the curing temperature must be strictly managed in order to obtain a stable performance from the cured product thereof. In addition, many (meth)acrylate compounds have skin sensitizing properties, which raises concerns regarding worker safety. In Patent Document 3, there is a concern about toxicity due to the aziridino groups and, since the resin is generally a water-soluble resin, there is a high possibility that the system will include a large amount of water, leading to the generation of voids and volumetric shrinkage.

It may be said that the gap filler of Patent Document 4 improves upon the drawbacks of gap fillers such as the silicone or polyurethane described above, as well as the epoxy-based, acrylic-based, or aziridino-functional polyether polymers of Patent Documents 1 to 3; however, cracking or peeling may sometimes occur in a case where the gap filler of Patent Document 4 is exposed to high temperatures for a long time or undergoes rapid temperature changes.

Accordingly, the present invention has an object of providing a resin composition for a heat-dissipating gap filler with which it is possible to reduce the occurrence of cracking and peeling even when the heat-dissipating gap filler is exposed to high temperature conditions for a long time or undergoes rapid temperature changes.

### Solution to Problem

As a result of extensive studies, the present inventors found that a resin composition for a heat-dissipating gap filler including a maleic anhydride-modified polybutadiene, a hydroxyl group-modified polybutadiene, a thermally conductive filler, and an antioxidant, in which the content of the antioxidant is 0.01% by mass or more when the total amount of the resin composition for a heat-dissipating gap filler is 100% by mass and the thermal conductance of the resin composition for a heat-dissipating gap filler after curing is 1.0 W/m·K or more, makes it possible for the resin composition for a heat-dissipating gap filler to reduce the occurrence of cracking and peeling even when the heat-dissipating gap filler is exposed to high temperature conditions for a long time or undergoes rapid temperature changes.

That is, the present invention provides a resin composition for a heat-dissipating gap filler, a heat-dissipating gap filler, and an article, as shown below.

[1]

A resin composition for a heat-dissipating gap filler including a maleic anhydride-modified polybutadiene, a hydroxyl group-modified polybutadiene, a thermally conductive filler, and an antioxidant, in which a content of the antioxidant is 0.01% by mass or more when a total amount of the resin composition for a heat-dissipating gap filler is 100% by mass, and a thermal conductance of the resin composition for a heat-dissipating gap filler after curing is 1.0 W/m·K or more.

[2]

The resin composition for a heat-dissipating gap filler according to [1], in which a content of the thermally conductive filler is 70% by mass or more when the total amount of the resin composition for a heat-dissipating gap filler is 100% by mass.

[3]

The resin composition for a heat-dissipating gap filler according to [1] or [2], in which the antioxidant includes at least one type selected from the group consisting of a phenol-based antioxidant and a phosphorus-based antioxidant.

[4]

The resin composition for a heat-dissipating gap filler according to [3], in which the antioxidant includes a phenol-based antioxidant.

[5]

The resin composition for a heat-dissipating gap filler according to any one of [1] to [4], further including a curing accelerator.

[6]

The resin composition for a heat-dissipating gap filler according to [5], in which the curing accelerator includes an amine-based curing accelerator.

[7]

The resin composition for a heat-dissipating gap filler according to [6], in which a pKa of the amine-based curing accelerator is 8.0 or more.

[8]

The resin composition for a heat-dissipating gap filler according to any one of [1] to [7], in which the resin composition for a heat-dissipating gap filler is a two liquid-type resin composition for a heat-dissipating gap filler.

[9]

The resin composition for a heat-dissipating gap filler according to [8], further including a liquid A including the maleic anhydride-modified polybutadiene and the thermally conductive filler, and a liquid B including the hydroxyl group-modified polybutadiene and the thermally conductive filler.

[10]

A heat-dissipating gap filler obtained by curing the resin composition for a heat-dissipating gap filler according to any one of [1] to [9].

[11]

An article including the heat-dissipating gap filler according to [10].

### Advantageous Effects of Invention

According to the present invention, it is possible to provide resin composition for a heat-dissipating gap filler with which it is possible to reduce the occurrence of cracking and peeling even when the heat-dissipating gap filler is exposed to high temperature conditions for a long time or undergoes rapid temperature changes.

### DESCRIPTION OF EMBODIMENTS

A detailed description will be given below of forms for carrying out the present invention. The present embodiment is only one form for carrying out the present invention and the present invention is not limited to the present embodiment and various modified embodiments are possible in a range not departing from the gist of the present invention. In addition, unless otherwise specified, “to” between numbers in the text indicates the first number or more and the second number or less.

### [Resin Composition for Heat-Dissipating Gap Filler]

The resin composition for a heat-dissipating gap filler of the present embodiment includes a maleic anhydride-modified polybutadiene, a hydroxyl group-modified polybutadiene, a thermally conductive filler, and an antioxidant, in which a content of the antioxidant is 0.01% by mass or more when the total amount of the resin composition for a heat-dissipating gap filler is 100% by mass and the thermal conductance of the resin composition for a heat-dissipating gap filler after curing is 1.0 W/m·K or more.

The thermal conductance of the resin composition for a heat-dissipating gap filler of the present embodiment after curing is 1.0 W/m·K or more. From the viewpoint of further improving the thermal conductivity, the thermal conductance of the resin composition for a heat-dissipating gap filler of the present embodiment after curing is preferably 1.5 W/m·K or more, more preferably 2.3 W/m·K or more, even more preferably 2.5 W/m·K or more, and yet more preferably 2.7 W/m·K or more. The upper limit value is not particularly limited, but may be, for example, 10.0 W/m·K or less, 8.0 W/m·K or less, or 5.0 W/m·K or less.

It is possible to set the thermal conductance of the resin composition for a heat-dissipating gap filler of the present embodiment after curing to the range of the present embodiment by, for example, adjusting the type, content, and the like of the thermally conductive filler and the type, content, and the like of the maleic anhydride-modified polybutadiene and the hydroxyl group-modified polybutadiene.

The thermal conductance of the resin composition for a heat-dissipating gap filler after curing indicates a value measured by the method described in the Examples.

From the viewpoint of further reducing the occurrence of cracking or peeling of the heat-dissipating gap filler, the Shore OO type hardness of the resin composition for a heat-dissipating gap filler of the present embodiment measured in accordance with ASTM D2240 is preferably 80 or less, more preferably 75 or less, and even more preferably 70 or less and the lower limit value thereof is not particularly limited, but may be, for example, 40 or more or 43 or more.

Hardness in the present specification indicates the hardness measured for samples produced by the method described in the Examples.

From the viewpoint of further reducing the occurrence of cracking or peeling of the heat-dissipating gap filler, the Shore 0 type hardness of the resin composition for a heat-dissipating gap filler of the present embodiment measured in accordance with ASTM D2240 is preferably 50 or less, more preferably 45 or less, and even more preferably 40 or less and the lower limit value thereof is not particularly limited, but may be, for example, 10 or more or 13 or more.

The resin composition for a heat-dissipating gap filler of the present embodiment is preferably a two liquid-type resin composition for a heat-dissipating gap filler. When using a two liquid-type resin composition for a heat-dissipating gap filler, the storage stability of the resin composition for a heat-dissipating gap filler before curing is further improved.

In a case where the resin composition for a heat-dissipating gap filler of the present embodiment is a two liquid-type resin composition for a heat-dissipating gap filler, a liquid A including the maleic anhydride-modified polybutadiene and the thermally conductive filler, and a liquid B including the hydroxyl group-modified polybutadiene and the thermally conductive filler are preferably included.

In a case where the resin composition for a heat-dissipating gap filler of the present embodiment is cured at room temperature, the maleic anhydride-modified polybutadiene and the hydroxyl group-modified polybutadiene, which are the resin components, are preferably not mixed during storage, but mixed before use. That is, an operation is performed in which the liquid A containing maleic anhydride-modified polybutadiene and the liquid B containing hydroxyl group-modified polybutadiene are stored separately, mixed before use, and then injected and coated and the result is cured to obtain a heat-dissipating gap filler.

In a case where the heat-dissipating gap filler is a two liquid-type, from the viewpoint of further improving the supply stability by using a pump in a coating device when coating the heat-dissipating gap filler, the viscosity of the liquid A is preferably 500 Pa·s or less, more preferably 400 Pa·s or less, even more preferably 300 Pa·s or less, and yet more preferably 280 Pa·s or less and, from the viewpoint of further improving the handling property, preferably 10 Pa·s or more, more preferably 20 Pa·s or more, even more preferably 50 Pa·s or more, yet more preferably 100 Pa·s or more, and still more preferably 200 Pa·s or more.

In a case where the heat-dissipating gap filler is a two liquid-type, from the viewpoint of further improving the supply stability when using the pump in the coating device when coating the heat-dissipating gap filler, the viscosity of the liquid B is preferably 500 Pa·s or less, more preferably 400 Pa·s or less, even more preferably 300 Pa·s or less, and yet more preferably 280 Pa·s or less and, from the viewpoint of further improving the handling property, preferably 10 Pa·s or more, more preferably 20 Pa·s or more, even more preferably 50 Pa·s or more, yet more preferably 100 Pa·s or more, and still more preferably 200 Pa·s or more.

The viscosity of the liquid A and the liquid B in the present specification indicates a value measured by the method described in the Examples.

In a case where the heat-dissipating gap filler is a two liquid-type, from the viewpoint of further improving the thermal conductivity, the thermal conductance of the liquid A is preferably 1.0 W/m·K or more, more preferably 1.5 W/m·K or more, even more preferably 2.0 W/m·K or more, yet more preferably 2.5 W/m·K or more, still more preferably 2.7 W/m·K or more, still more preferably 3.0 W/m·K or more, and still more preferably 3.5 W/m·K or more. The upper limit value is not particularly limited, but may be, for example, 10.0 W/m·K or less, 8.0 W/m·K or less, or 5.0 W/m·K or less.

In a case where the heat-dissipating gap filler is a two liquid-type, from the viewpoint of further improving the thermal conductivity, the thermal conductance of the liquid B is preferably 1.0 W/m·K or more, more preferably 1.5 W/m·K or more, even more preferably 2.0 W/m·K or more, yet more preferably 2.5 W/m·K or more, still more preferably 2.7 W/m·K or more, still more preferably 3.0 W/m·K or more, and still more preferably 3.5 W/m·K or more. The upper limit value is not particularly limited, but may be, for example, 10.0 W/m·K or less, 8.0 W/m·K or less, or 5.0 W/m·K or less.

The thermal conductance of the liquid A and the liquid B in the present specification indicates a value measured by the method described in the Examples.

A description will be given below of each component forming the resin composition for a heat-dissipating gap filler.

### <Maleic Anhydride-Modified Polybutadiene>

The maleic anhydride-modified polybutadiene of the present embodiment is produced by modifying a butadiene homopolymer with maleic anhydride and specific examples thereof include RICON 130MA8, RICON 131MA5, RICOBOND 1731, and RICOBOND 1756 produced by Cray Valley, POLYVEST MA75 produced by Evonik, and the like.

From the viewpoint of further improving the performance balance between the handling property and sheet formability, when the total amount of the resin composition for a heat-dissipating gap filler of the present embodiment is 100% by mass, the content of the maleic anhydride-modified polybutadiene of the present embodiment is preferably 0.2% by mass or more, more preferably 0.5% by mass or more, even more preferably 1.0% by mass or more, and yet more preferably 1.2% by mass or more and, from the viewpoint of setting the viscosity to a more appropriate range, preferably 10.0% by mass or less, more preferably 7.0% by mass or less, even more preferably 6.0% by mass or less, and yet more preferably 5.5% by mass or less.

In a case where the heat-dissipating gap filler is a two liquid-type, from the viewpoint of further improving the handling property, when the total amount of the liquid A is 100% by mass, the content of the maleic anhydride-modified polybutadiene included in the liquid A is preferably 0.5% by mass or more, more preferably 1.0% by mass or more, even more preferably 2.0% by mass or more, and yet more preferably 2.4% by mass or more and, from the viewpoint of setting the viscosity to a more appropriate range, preferably 20.0% by mass or less, more preferably 14.0% by mass or less, even more preferably 12.0% by mass or less, and yet more preferably 11.0% by mass or less.

### <Hydroxy Group-Modified Polybutadiene>

In addition, the hydroxyl group-modified polybutadiene of the present embodiment is obtained by hydroxylating polybutadiene and specific examples thereof include Poly bd R-20LM produced by Cray Valley, Poly bd R-15HT and Poly bd R-45HT produced by Idemitsu Kosan Co., Ltd., POLYVEST HT produced by Evonik, NISSO-PB G-1000, NISSO-PB G-2000, and NISSO-PB G-3000 produced by Nippon Soda Co., Ltd., Hydroxyl-terminated Polymer Butadiene produced by Zibo, and the like.

From the viewpoint of further improving the handling property, when the total amount of the resin composition for a heat-dissipating gap filler of the present embodiment is 100% by mass, the content of the hydroxyl group-modified polybutadiene of the present embodiment is preferably 0.2% by mass or more, more preferably 0.3% by mass or more, even more preferably 0.4% by mass or more, and yet more preferably 0.5% by mass or more and, from the viewpoint of setting the viscosity to a more appropriate range, preferably 10.0% by mass or less, more preferably 7.0% by mass or less, even more preferably 5.0% by mass or less, yet more preferably 3.0% by mass or less, still more preferably 2.0% by mass or less, and still more preferably 1.8% by mass or less.

In a case where the heat-dissipating gap filler is a two liquid-type, from the viewpoint of further improving the handling property, when the total amount of the liquid B is 100% by mass, the content of the hydroxyl group-modified polybutadiene included in the liquid B is preferably 0.5% by mass or more, more preferably 0.7% by mass or more, and even more preferably 1.0% by mass or more and, from the viewpoint of setting the viscosity to a more appropriate range, preferably 20.0% by mass or less, more preferably 14.0% by mass or less, even more preferably 10.0% by mass or less, yet more preferably 6.0% by mass or less, still more preferably 4.0% by mass or less, and still more preferably 3.6% by mass or less.

The content of the maleic anhydride-modified polybutadiene of the present embodiment and the hydroxyl group-modified polybutadiene of the present embodiment is determined in consideration of the number of maleic anhydride residues in the maleic anhydride-modified polybutadiene involved in the reaction, the number of hydroxyl groups in the hydroxyl group-modified polybutadiene, and the physical properties of the resin to be obtained after the reaction. When the total amount of the resin composition for a heat-dissipating gap filler of the present embodiment is 100% by mass, the total content of the maleic anhydride-modified polybutadiene of the present embodiment and the hydroxyl group-modified polybutadiene of the present embodiment is, for example, 0.01 to 25% by mass and preferably 0.5 to 25% by mass.

From the viewpoint of further improving the handling property, when the total amount of the resin composition for a heat-dissipating gap filler of the present embodiment is 100% by mass, the total content of the maleic anhydride-modified polybutadiene of the present embodiment and the hydroxyl group-modified polybutadiene of the present embodiment is preferably 0.01% by mass or more, more preferably 0.1% by mass or more, even more preferably 0.5% by mass or more, yet more preferably 1.0% by mass or more, still more preferably 2.0% by mass or more, and still more preferably 3.0% by mass or more and, from the viewpoint of setting the viscosity to a more appropriate range, preferably 25% by mass or less, more preferably 20% by mass or less, even more preferably 15% by mass or less, and yet more preferably 10% by mass or less.

### <Thermally Conductive Filler>

It is possible to use any known thermally conductive filler as the thermally conductive filler in the present embodiment, but, in a case where the breakthrough voltage is a concern, an electrically insulating thermally conductive filler is preferable.

Examples of electrically insulating thermally conductive fillers include inorganic particles such as oxides, hydrates, nitrides, carbonates, and carbides, and as oxides, for example, silicon oxide, aluminum oxide, magnesium oxide, zinc oxide, and the like are preferably used, as hydrates, for example, aluminum hydroxide, magnesium hydroxide, and the like are preferably used; as nitrides, for example, boron nitride and aluminum nitride are preferably used; as carbonates, for example, magnesium carbonate and anhydrous magnesium carbonate are preferably used; and, as a carbide, for example, silicon carbide is preferably used. In addition, without considering electrical insulation, it is also possible to use graphite, carbon nanotubes, and metals such as aluminum.

The thermally conductive filler of the present embodiment preferably includes at least one selected from the group consisting of aluminum oxide, aluminum hydroxide, aluminum nitride, zinc oxide, anhydrous magnesium carbonate, and silicon carbide.

From the viewpoint of further improving the thermal conductivity, when the total amount of the resin composition for a heat-dissipating gap filler of the present invention is 100% by mass, the content of the thermally conductive filler of the present embodiment is preferably 70% by mass or more, more preferably 75% by mass or more, even more preferably 80% by mass or more, and yet more preferably 85% by mass or more and, from the viewpoint of further improving the handling property, preferably 99% by mass or less, more preferably 97% by mass or less, and even more preferably 95% by mass or less.

In a case where the heat-dissipating gap filler is a two liquid-type, the thermally conductive filler is preferably contained in each of the liquid A and the liquid B. By the thermally conductive filler being contained in each of the liquid A and the liquid B, it is possible to balance the viscosity of the liquid A and the liquid B more appropriately and further improve the operability when mixing the liquid A and the liquid B.

In a case where the heat-dissipating gap filler is a two liquid-type, from the viewpoint of further improving the thermal conductivity, when the total amount of the liquid A is 100% by mass, the content of the thermally conductive filler included in the liquid A is preferably 70% by mass or more, more preferably 75% by mass or more, even more preferably 80% by mass or more, and yet more preferably 85% by mass or more and, from the viewpoint of further improving the handling property, preferably 99% by mass or less, more preferably 97% by mass or less, and even more preferably 95% by mass or less.

In a case where the heat-dissipating gap filler is a two liquid-type, from the viewpoint of further improving the thermal conductivity, when the total amount of the liquid B is 100% by mass, the content of the thermally conductive filler included in the liquid B is preferably 70% by mass or more, more preferably 75% by mass or more, even more preferably 80% by mass or more, and yet more preferably 85% by mass or more and, from the viewpoint of further improving the handling property, preferably 99% by mass or less, more preferably 97% by mass or less, and even more preferably 95% by mass or less.

For these thermally conductive fillers, it is possible to control the thermal conductivity or control the viscosity of the resin composition by using one or two or more types thereof, by using a combination of inorganic particles of the same type but with different particle sizes, or by adjusting the content thereof and, in order to control the viscosity of the resin composition for a heat-dissipating gap filler in a range in which it is possible to easily carry out operations such as injection and coating while aiming to maximize thermal conductivity, it is preferable to use a combination of inorganic particles having different particle sizes. By doing so, it is possible to further improve the thermal conductance while adjusting the viscosity to an appropriate level. In addition, in a case of imparting flame retardancy or the like, for example, it is also possible to use a hydrate, for instance, by selecting aluminum hydroxide or magnesium hydroxide instead of an oxide.

### <Antioxidant>

Since the purpose of the heat-dissipating gap filler is heat dissipation, the heat-dissipating gap filler is naturally used in places which are exposed to high temperatures for long periods of time or repeatedly exposed to high temperatures and room temperature.

In addition to thermal degradation of the double bonds derived from butadiene chains due to heat, water, and oxygen, the resin composition for a heat-dissipating gap filler of the present embodiment is prone to cross-linking reactions between butadiene chains, resulting in the obtained heat-dissipating gap filler becoming hard and brittle, causing cracking and peeling. In order to further reduce this cracking and peeling, the resin composition for a heat-dissipating gap filler of the present embodiment contains an antioxidant.

As the antioxidant, it is possible to use known antioxidants and it is preferable to include at least one selected from the group consisting of phenol-based antioxidants, phosphorus-based antioxidants, thiol-based antioxidants, diphenylamine-based antioxidants, ascorbic acid-based antioxidants, and hindered amine-based antioxidants, more preferable to include at least one selected from the group consisting of phenol-based antioxidants and phosphorus-based antioxidants, and even more preferable to include phenol-based antioxidants.

As the antioxidant, it is preferable to use one or two or more of a primary antioxidant and/or a secondary antioxidant.

The primary antioxidant prevents oxidative deterioration of the resin by capturing peroxy radicals. As this primary antioxidant, it is possible to use any known primary antioxidant, but phenol-based antioxidants are preferable and examples thereof include hexamethylene bis[(3,5-di-tert-butyl-4-hydroxyphenyl)propionic acid amide], 4,4′-thiobis(6-tert-butyl-m-cresol), 2,2′-methylenebis(4-methyl-6-tert-butylphenol), bis[3,3-bis(4-hydroxy-3-tert-butylphenyl)butyric acid] glycol ester, 2,2′-ethylidenebis(4,6-di-tert-butylphenol), 2,2′-ethylidenebis(4-sec-butyl-6-tert-butylphenol), 1,1,3-tris(2-methyl-4-hydroxy-5-tert-butylphenyl)butane, bis[2-tert-butyl-4-methyl-6-(2-hydroxy-3-tert)-butyl-5-methylbenzyl)phenyl]terephthalate, 1,3,5-tris (3,5-di-tert-butyl-4-hydroxybenzyl)-2,4,6-trimethylbenzene, 1,3,5-tris[(3,5-di-tert-butyl-4-hydroxyphenyl)propionyloxyethyl]isocyanurate, 2-tert-butyl-4-methyl-6-(2-acryloyloxy-3-tert-butyl-5-methylbenzyl)phenol, 3,9-bis[1,1-dimethyl-2-{(3-tert-butyl-4-hydroxy-5-methylphenyl)propionyloxy}ethyl]-2,4,8,10-tetraoxaspiro[5.5]undecane, triethylene glycol bis[(3-tert-butyl-4-hydroxy-5-methylphenyl)propionate], n-octadecyl-3-(4′-hydroxy-3′,5′-di-tert-butylphenyl)butane, pentaerythritol tetrakis [3-(3,5-di-tert-butyl-4-hydroxyphenyl)propionate], thiodiethylenebis[3-(3,5-di-tert-butyl-4-hydroxyphenyl)propionate], N,N′-hexane-1,6-diylbis[3-(3,5-di-tert-butyl-hydroxyphenyl)propionate], 1,3,5-tris(3,5-di-t-butyl-4-hydroxybenzyl)-1,3,5-triazine-2,4,6(1H,3H,5H)trione, 3,5-bis(1,1-dimethylethyl)-4-methyl hydroxybenzene propionate, 3,5-bis(1,1-dimethylethyl)-4-hydroxy-C7-C9 side chain alkyl esters of benzene propanoic acid, 4,6-bis(octylthiomethyl)-o-cresol, and the like. From the viewpoint of further preventing cracking or peeling of the heat-dissipating gap filler and maintaining an appropriate hardness, the phenol-based antioxidants preferably include at least one selected from the group consisting of 4,4′-thiobis(6-tert-butyl-m-cresol), thiodiethylenebis[3-(3,5-di-tert-butyl-4-hydroxyphenyl)propionate], and 4,6-bis(octylthiomethyl)-o-cresol.

The secondary antioxidant decomposes hydroxide radicals generated by oxidation of double bonds and prevents oxidative deterioration of the resin. As the secondary antioxidant, it is possible to apply secondary antioxidants known in the related art, but phosphorus-based antioxidants are preferable and examples thereof include trisnonylphenyl phosphite, tris(2,4-di-tert-butylphenyl)phosphite, tris[2-tert-butyl-4-(3-tert-butyl-4-hydroxy-5-methylphenylthio)-5-methylphenyl] phosphite, tridecyl phosphite, octyldiphenyl phosphite, di(decyl)monophenyl phosphite, di(tridecyl)pentaerythritol diphosphite, distearylpentaerythritol diphosphite, di(nonylphenyl)pentaerythritol diphosphite, bis(2,4-di-tert-butylphenyl)pentaerythritol diphosphite, bis(2,6-di-tert-butyl-4-methylphenyl) pentaerythritol diphosphite, bis(2,4,6-tri-tert-butylphenyl)pentaerythritol diphosphite, tetra(tridecyl)isopropylidene diphenol diphosphite, tetra(tridecyl)-4,4′-n-butylidenebis(2-tert-butyl-5-methylphenol)diphosphite, hexa(tridecyl)-1,1,3-tris(2-methyl-4-hydroxy-5-tert-butylphenyl)butane triphosphite, tetrakis(2,4-di-tert-butylphenyl)biphenylene diphosphonite, 9,10-dihydro-9-oxa-10-phosphaphenanthrene-10-oxide, 2,2′-methylenebis(4-methyl-6-tert-butylphenyl)-2-ethylhexylphosphite, 4-[3-[(2,4,8,10-tetra-tert-butyldibenzo[d,f][1,3,2]dioxaphosphepin)-6-yloxy]propyl]-2-methyl-6-tert-butylphenol, and the like.

In consideration of expressing the oxidation preventing effect without sacrificing other performances, when the total amount of the resin composition for a heat-dissipating gap filler of the present embodiment is 100% by mass, the content of these antioxidants is, for example, 0.01 to 20% by mass and preferably 0.4 to 20% by mass.

When the total amount of the resin composition for a heat-dissipating gap filler of the present embodiment is 100% by mass, the content of the antioxidant is 0.01% by mass or more and, from the viewpoint of further improving the oxidation preventing effect, preferably 0.05% by mass or more, more preferably 0.1% by mass or more, even more preferably 0.4% by mass or more, yet more preferably 0.5% by mass or more and, from the viewpoint of further improving the balance of the thermal conductivity, handling property, and the like, preferably 20.0% by mass or less, more preferably 15.0% by mass or less, even more preferably 10.0% by mass or less, yet more preferably 8.0% by mass or less, still more preferably 5.0% by mass or less, still more preferably 3.0% by mass or less, and still more preferably 1.0% by mass or less.

In a case where the heat-dissipating gap filler is a two liquid-type, the antioxidant may be included in only one of the liquid A or the liquid B, or may be included in both the liquid A and the liquid B.

From the viewpoint of further improving the oxidation preventing effect, when the total amount of the liquid A is 100% by mass, the content of the antioxidant included in the liquid A is preferably 0.025% by mass or more, more preferably 0.05% by mass or more, even more preferably 0.1% by mass or more, and yet more preferably 0.2% by mass or more and, from the viewpoint of further improving the balance of thermal conductivity, handling property, and the like, preferably 25.0% by mass or less, more preferably 20.0% by mass or less, even more preferably 15.0% by mass or less, yet more preferably 10.0% by mass or less, still more preferably 8.0% by mass or less, still more preferably 5.0% by mass or less, still more preferably 3.0% by mass or less, still more preferably 1.5% by mass or less, still more preferably 1.0% by mass or less, and still more preferably 0.5% by mass or less.

From the viewpoint of further improving the oxidation preventing effect, when the total amount of the liquid B is 100% by mass, the content of the antioxidant included in the liquid B is preferably 0.025% by mass or more, more preferably 0.05% by mass or more, even more preferably 0.1% by mass or more, and yet more preferably 0.2% by mass or more and, from the viewpoint of further improving the balance of thermal conductivity, handling property, and the like, preferably 25.0% by mass or less, more preferably 20.0% by mass or less, even more preferably 15.0% by mass or less, yet more preferably 10.0% by mass or less, still more preferably 8.0% by mass or less, still more preferably 5.0% by mass or less, still more preferably 3.0% by mass or less, still more preferably 1.5% by mass or less, still more preferably 1.0% by mass or less, and still more preferably 0.5% by mass or less.

### <Curing Accelerator>

The resin composition for a heat-dissipating gap filler of the present embodiment preferably further includes a curing accelerator from the viewpoint of accelerating the curing reaction.

The curing accelerator is not particularly limited other than having the effect of accelerating the curing reaction, but amine-based curing accelerators are preferable. Among amine-based curing accelerators, the pKa of the amine-based curing accelerator is preferably 8.0 or more, more preferably 9.0 or more, and even more preferably 9.5 or more. Specifically, examples thereof include imidazoles such as 2-ethyl-4-ethylimidazole and 1-cyanoethyl-2-ethyl-4-ethylimidazole, tertiary amines such as benzyldimethylamine, 2,4,6-tris(dimethylaminomethyl)phenol, 1,8-diazabicyclo[5.4.0]undecene-7(DBU), 1,5-diazabicyclo(4,3,0)nonene-5(DBN), hexahydro-1,3,5-tris(3-dimethylaminopropyl)-1,3,5-triazine, N, N,N′,N″,N″-pentamethyldiethylenetriamine, N,N,N′,N′-tetramethylhexamethylenediamine, and N-methyl dicyclohexylamine, secondary amines such as 4,4′-methylenebis(N-sec-butylcyclohexaneamine) and N,N′-di-sec-butyl-p-phenylenediamine, DBU or DBN octylate, 1,1,3,3-tetramethylguanidine, and the like.

In consideration of adjusting the initial curing time to a suitable level, the content of these curing accelerators is preferably 0.01 to 5% by mass with respect to the total amount of the resin composition for a heat-dissipating gap filler of the present invention.

### <Plasticizer>

The resin composition for a heat-dissipating gap filler of the present embodiment preferably further includes a plasticizer from the viewpoint of adjusting the viscosity of the resin.

The plasticizer is preferably a liquid at room temperature with a flash point of 200° C. or higher so as to remain inside a cured product and it is possible to use one or two or more types of plasticizer as long as the plasticizer is a liquid that does not inhibit the curing reaction. Examples thereof include esters such as di-2-ethylhexyl phthalate (DOP), diisononyl phthalate (DINP), diisodecyl phthalate (DIDP), di-2-ethylhexyl adipate (DOA), diisononyl adipate (DINA), tri-trimellitate-2-ethylhexyl (TOTM), and tricresyl phosphate (TCP), fatty acid esters modified with animal and vegetable oils, and the like.

From the viewpoint of keeping the viscosity of the resin in a more appropriate range, when the total amount of the resin composition for a heat-dissipating gap filler of the present embodiment is 100% by mass, the content of the plasticizer of the present embodiment is preferably 1% by mass or more, more preferably 2% by mass or more, even more preferably 3% by mass or more and, from the viewpoint of further improving the balance of thermal conductivity, handling property, and the like, preferably 10% by mass or less, more preferably 9% by mass or less, and even more preferably 8% by mass or less.

### <Dispersing Agent>

The resin composition for a heat-dissipating gap filler of the present embodiment preferably further includes a dispersing agent from the viewpoint of further improving the dispersibility of the thermally conductive filler.

The dispersing agent is not particularly limited other than having an effect of improving the wettability with the resin and helping to improve the dispersibility for the purpose of surface modification of the thermally conductive filler and examples thereof include cationic, anionic, non-ionic, and amphoteric surfactants, of which it is possible to use one or two or more. Specifically, examples thereof include KP (produced by Shin-Etsu Chemical Co., Ltd.), Flowlen (produced by Kyoeisha Chemical Co., Ltd.), Solsperse (produced by Lubrizol Corp.), EFKA (produced by BASF), Ajisper (produced by Ajinomoto Fine-Techno Co., Inc.), Disperbyk and BYK (produced by BYK Chemie Co., Ltd.), Malialim (produced by NOF Corp.), Disparlon (produced by Kusumoto Chemicals, Ltd.), and the like. The above may be blended during the production of the liquid A or the liquid B, or may be processed in the filler in advance.

From the viewpoint of further improving the dispersibility of the thermally conductive filler, when the total amount of the resin composition for a heat-dissipating gap filler of the present embodiment is 100% by mass, the content of the dispersing agent of the present embodiment is preferably 0.05% by mass or more, more preferably 0.1% by mass or more, and even more preferably 0.2% by mass or more and, from the viewpoint of further improving the balance of thermal conductivity, handling property, and the like, preferably 1.0% by mass or less, more preferably 0.8% by mass or less, and even more preferably 0.6% by mass or less.

### <Other Components>

Furthermore, in addition to the additives described above, it is possible to blend, as necessary, coupling agents, rheology control agents, antifoaming agents, flame retardants, anti-settling agents, coloring agents, and the like that are generally blended with this type of composition in a range not inhibiting the effects of the present invention.

### [Method for Producing Resin Composition for Heat-Dissipating Gap Filler]

The resin composition for a heat-dissipating gap filler of the present embodiment may be obtained by mixing each material using a high-viscosity kneader such as a ball mill, a three-roll mill, a kneader, a planetary mixer, or a screw extruder.

In a case where the heat-dissipating gap filler is a two liquid-type, for each of the liquid A and the liquid B, each material is mixed using a high-viscosity kneader such as a ball mill, a three-roll mill, a kneader, a planetary mixer, or a screw extruder.

### [Method for Using Resin Composition for Heat-Dissipating Gap Filler]

As the method for using the resin composition for a heat-dissipating gap filler, for example, a resin composition for a heat-dissipating gap filler is injected into a gap between articles, or articles are bonded together by coating the resin composition for a heat-dissipating gap filler and then pasting the articles together at the coated surfaces of the articles.

In a case where the heat-dissipating gap filler is a two liquid-type, for example, the liquid A and the liquid B are mixed at a volume ratio of 1:1 and injected into a gap between the articles, or articles are bonded together by carrying out the coating and then pasting the articles together at the coated surfaces of the articles. Naturally, it is also possible to carry out the mixing according to the weight ratio, but a method for measuring the volume and mixing is generally used in this type of operation for simplicity.

### [Heat-Dissipating Gap Filler]

The heat-dissipating gap filler of the present embodiment is obtained by curing the resin composition for a heat-dissipating gap filler of the present embodiment. For the heat-dissipating gap filler of the present embodiment, at least a part of the resin composition for a heat-dissipating gap filler of the present embodiment may be cured.

The heat-dissipating gap filler of the present embodiment is obtained, for example, by curing the resin composition for a heat-dissipating gap filler of the present embodiment at room temperature (for example, 21° C. or higher and 25° C. or lower).

In a case where the heat-dissipating gap filler is a two liquid-type, the initial curing time after mixing the liquid A and the liquid B varies depending on the type of curing accelerator, amount used, and temperature, but, in the present invention, it is possible to control the initial curing time to be 5 to 60 minutes at room temperature (for example, 21° C. or higher and 25° C. or lower), which is said to be practically preferable, after which full curing takes approximately 1 to 3 days. In addition, after curing, the result has excellent adhesion and moderate flexibility and thus will not peel or crack for a long period of time even under harsh conditions.

### [Article]

The article of the present embodiment includes the heat-dissipating gap filler of the present embodiment. The article of the present embodiment is an electronic device such as a digital home appliance, a lithium-ion secondary battery, a vehicle-mounted power module, or the like.

### EXAMPLES

A more detailed description will be given below of the present invention with reference to Examples, but the present invention is not limited to these Examples. In addition, in the Examples, “parts” represent “parts by mass.”

### Production Example 1

### Production of Liquid A-1

2.70 parts of RICON 130MA8 (maleic anhydride-modified polybutadiene produced by Cray Valley), 6.00 parts of diisononyl phthalate (plasticizer produced by New Japan Chemical Co., Ltd.), 25 parts of B-325 (aluminum hydroxide produced by Almorix Ltd.), 31 parts of T-60 75MY (aluminum oxide produced by Almatis), 25 parts of LS-210B (aluminum oxide produced by Nippon Light Metal Co., Ltd.), and 10.3 parts of ASFP-20 (aluminum oxide produced by Denka Co., Ltd.) were mixed and stirred using a rotation and revolution mixer ARE-310 manufactured by THINKY Corp., to obtain 100 parts of a liquid A-1.

### Production Example 2

### Production of Liquid B-1

1.05 parts of Poly bd R-20LM (hydroxyl group-modified polybutadiene produced by Cray Valley), 0.02 parts of Lupragen N700 (curing accelerator produced by BASF), 6.63 parts of diisononyl phthalate (plasticizer produced by Shin Nippon Chemical Co., Ltd.), 25 parts of B-325 (aluminum hydroxide produced by Almorix), 31 parts of T-60 75MY (aluminum oxide produced by Almatis), 25 parts of LS-210B (aluminum oxide produced by Nippon Light Metal Co., Ltd.), 10.3 parts of ASFP-20 (aluminum oxide produced by Denka Co., Ltd.), and 1.00 parts of DISPERBYK-145 (dispersing agent produced by BYK Chemie Co., Ltd.) were mixed and stirred using a rotation and revolution mixer ARE-310 manufactured by THINKY Corp., to obtain 100 parts of a liquid B-1.

Liquid A-2 to liquid A-8 were obtained in accordance with the blends in Table 1 by the same operation as in Production Example 1 and liquid B-2 to liquid B-33 were obtained in accordance with the blends in Table 2, Table 3, and Table 4 by the same operation as in Production Example 2. The average particle diameters of inorganic particles such as aluminum oxide listed in Tables 1 to 4 are the catalog values of the respective makers.

TABLE 1

| | | | Average | | | | | | | | |
|---|---|---|---|---|---|---|---|---|---|---|---|
| | | | particle | | | | | | | | |
| Material | Maker | | diameter | Liquid | Liquid | Liquid | Liquid | Liquid | Liquid | Liquid | Liquid |
| name | or agent | Material type | μm | A-1 | A-2 | A-3 | A-4 | A-5 | A-6 | A-7 | A-8 |
| RICON | Cray Valley | Maleic anhydride-modified | | 2.7 | 2.7 | | | | | | |
| 130MA8 | | polybutadiene | | | | | | | | | |
| POLYVEST | Evonik | Maleic anhydride-modified | | | | 2.7 | 3.5 | 3.5 | 3.5 | 10 | 5.5 |
| MA75 | | polybutadiene | | | | | | | | | |
| DINP | New Japan | Plasticizer | | 6 | 6 | 6 | | | | | |
| | Chemical | | | | | | | | | | |
| | Co., Ltd. | | | | | | | | | | |
| BIOCIZER | Riken Vitamin | Plasticizer | | | | | 6.5 | 4.5 | | | 3.5 |
| Irganox 1010 | BASF | Antioxidant (phenol-based) | | | 0.15 | 0.05 | | 1 | | | |
| Irganox 1135 | BASF | Antioxidant (phenol-based) | | | | | | | 6.5 | 20 | |
| Irgafos 168 | BASF | Antioxidant | | | 0.15 | 0.05 | | 1 | | | |
| | | (phosphorus-based) | | | | | | | | | |
| TIXOGEL | BYK Chemie | Rheology control agent | | | | 0.2 | | | | | |
| VP | Co., Ltd. | | | | | | | | | | |
| T-60 75MY | Almatis | Aluminum oxide | 16 | 31 | 31 | 31 | | | | | |
| B-325 | Almorix | Aluminum hydroxide | 28 | 25 | 25 | 25 | | | | 70 | |
| LS-210B | Nippon Light | Aluminum oxide | 4 | 25 | 25 | 25 | | | | | |
| | Metal Co., Ltd. | | | | | | | | | | |
| ASFP-20 | Denka Co., Ltd. | Aluminum oxide | 0.3 | 10.3 | 10 | 10 | | | | | 10 |
| AA-18 | Sumitomo | Aluminum oxide | 20 | | | | 60 | 60 | 60 | | |
| | Chemical | | | | | | | | | | |
| | Co., Ltd. | | | | | | | | | | |
| AA-3 | Sumitomo | Aluminum oxide | 4 | | | | 20 | 20 | 20 | | 21 |
| | Chemical | | | | | | | | | | |
| | Co., Ltd. | | | | | | | | | | |
| AA-03 | Sumitomo | Aluminum oxide | 0.4 | | | | 10 | 10 | 10 | | |
| | Chemical | | | | | | | | | | |
| | Co., Ltd. | | | | | | | | | | |
| AZ35-125 | Nippon Steel | Aluminum oxide | 37 | | | | | | | | 60 |
| | Chemical & | | | | | | | | | | |
| | Material Co., | | | | | | | | | | |
| | Ltd. | | | | | | | | | | |

| | | | | | | | | |
|---|---|---|---|---|---|---|---|---|
| Viscosity Pa · s | 210 | 220 | 210 | 252 | 267 | 113 | 26 | 260 |
| Thermal conductivity W/m · K | 2.9 | 2.9 | 2.9 | 3.0 | 3.0 | 3.0 | 1.0 | 3.7 |

TABLE 2

| | | | Average | | | | | | | | | | |
|---|---|---|---|---|---|---|---|---|---|---|---|---|---|
| | | | particle | | Liq- | Liq- | Liq- | Liq- | Liq- | Liq- | Liq- | Liq- | Liq- |
| Material | Maker | | diameter | | uid | uid | uid | uid | uid | uid | uid | uid | uid |
| name | or agent | Material type | μm | pKa | B-1 | B-2 | B-3 | B-4 | B-5 | B-6 | B-7 | B-8 | B-9 |
| Poly bd | Cray Valley | Hydroxyl | | | 1.05 | 1.05 | 1.56 | | | | | | |
| R-20LM | | group-modified | | | | | | | | | | | |
| | | polybutadiene | | | | | | | | | | | |
| POLYVEST | Evonik | Hydroxyl | | | | | | 1.5 | 1.5 | 1.5 | 1.5 | 1.5 | 1.5 |
| HT | | group-modified | | | | | | | | | | | |
| | | polybutadiene | | | | | | | | | | | |
| Lupragen N700 | BASF | Curing accelerator | | 12.5 | 0.02 | 0.02 | | 0.02 | 0.02 | 0.02 | 0.02 | 0.02 | 0.02 |
| Clearlink1000 | Dorf Ketal | Curing accelerator | | 11.5 | | | 0.14 | | | | | | |
| Lupragen N600 | BASF | Curing accelerator | | 10 | | | | | | | | | |
| DINP | New Japan | Plasticizer | | | 6.63 | 6.63 | 8.3 | 6.48 | 6.48 | 6.48 | 4.48 | 6.48 | 6.48 |
| | Chemical | | | | | | | | | | | | |
| | Co., Ltd. | | | | | | | | | | | | |
| DISPERBYK- | BYK Chemie | Dispersing agent | | | 1 | 1 | 1 | 1 | 1 | 1 | 1 | 1 | 1 |
| 145 | Co., Ltd. | | | | | | | | | | | | |
| Irganox 1010 | BASF | Antioxidant | | | | 0.15 | 0.5 | | | | | | |
| | | (phenol-based) | | | | | | | | | | | |
| Irgafos 168 | BASF | Antioxidant | | | | 0.15 | 0.5 | | | | | | |
| | | (phosphorus- | | | | | | | | | | | |
| | | based) | | | | | | | | | | | |
| T-60 75MY | Almatis | Aluminum oxide | 16 | | 31 | 31 | | | | | | | |
| AZ35-125 | Nippon Steel | Aluminum oxide | 37 | | | | | 56 | | | | 31 | 56 |
| | Chemical & | | | | | | | | | | | | |
| | Material | | | | | | | | | | | | |
| | Co., Ltd. | | | | | | | | | | | | |
| AA-18 | Sumitomo | Aluminum oxide | 20 | | | | | | 56 | | | | |
| | Chemical | | | | | | | | | | | | |
| | Co., Ltd. | | | | | | | | | | | | |
| B-325 | Almorix | Aluminum | 28 | | 25 | 25 | 50 | | | | | | |
| | | hydroxide | | | | | | | | | | | |
| AIN3001 | Showa Denko | Aluminum | 33 | | | | | | | 50 | | | |
| | | nitride | | | | | | | | | | | |
| LPZINC-20 | Sakai Chemical | Zinc oxide | 20 | | | | | | | | 65 | | |
| | Industry | | | | | | | | | | | | |
| | Co., Ltd. | | | | | | | | | | | | |
| MAGTHERMO | Konoshima | Anhydrous | 21 | | | | | | | | | 25 | |
| MS-PS | Chemical | magnesium | | | | | | | | | | | |
| | Co., Ltd. | carbonate | | | | | | | | | | | |
| LS-210B | Nippon Light | Aluminum oxide | 4 | | 25 | 25 | 28 | 25 | | 31 | 20 | 25 | 25 |
| | Metal Co., Ltd. | | | | | | | | | | | | |
| AA-3 | Sumitomo | Aluminum oxide | 4 | | | | | | 25 | | | | |
| | Chemical | | | | | | | | | | | | |
| | Co., Ltd. | | | | | | | | | | | | |
| ASFP-20 | Denka Co., Ltd. | Aluminum oxide | 0.3 | | 10.3 | 10 | 10 | 10 | | 10 | 8 | 10 | |
| AA-03 | Sumitomo | Aluminum oxide | 0.4 | | | | | | 10 | | | | |
| | Chemical | | | | | | | | | | | | |
| | Co., Ltd. | | | | | | | | | | | | |
| GMF 15H2 | Pacific Rundum | Silicon carbide | 0.5 | | | | | | | | | | 10 |
| | Co., Ltd. | | | | | | | | | | | | |

| | | | | | | | | | |
|---|---|---|---|---|---|---|---|---|---|
| Viscosity Pa · s | 85 | 90 | 170 | 63 | 194 | 107 | 295 | 67 | 74 |
| Thermal conductivity W/m · K | 2.9 | 2.9 | 2.1 | 3.0 | 3.4 | 4.2 | 3.3 | 2.7 | 3.0 |

TABLE 3

| | | | Average | | | | | | | | |
|---|---|---|---|---|---|---|---|---|---|---|---|
| | | | particle | | Liq- | Liq- | Liq- | Liq- | Liq- | Liq- | Liq- |
| Material | Maker | | diameter | | uid | uid | uid | uid | uid | uid | uid |
| name | or agent | Material type | μm | pKa | B-10 | B-11 | B-12 | B-13 | B-14 | B-15 | B-16 |
| POLYVEST | Evonik | Hydroxyl group-modified | | | 3.5 | 3.5 | 3.5 | 3.5 | 3.5 | 3.5 | 11 |
| HT | | polybutadiene | | | | | | | | | |
| Lupragen N700 | BASF | Curing accelerator | | 12.5 | | | | | | | 0.8 |
| Clearlink1000 | Dorf Ketal | Curing accelerator | | 11.5 | 0.5 | 0.5 | 0.5 | | | | |
| Lupragen N600 | BASF | Curing accelerator | | 10 | | | | 0.5 | | | |
| 2,4,6-Tris | Kanto | Curing accelerator | | 8.4 | | | | | 5 | | |
| (dimethyl- | Chemical | | | | | | | | | | |
| aminomethyl) | Co., Ltd. | | | | | | | | | | |
| phenol | | | | | | | | | | | |
| Triethanol- | Kanto | Curing accelerator | | 7.8 | | | | | | 5 | |
| amine | Chemical | | | | | | | | | | |
| | Co., Ltd. | | | | | | | | | | |
| BIOCIZER | Riken Vitamin | Plasticizer | | | 6 | 4 | | 4 | | 1.5 | |
| Irganox 1010 | BASF | Antioxidant (phenol-based) | | | | 1 | | 1 | | | |
| Irganox 1135 | BASF | Antioxidant (phenol-based) | | | | | 6 | | | | 18.2 |
| Irgafos 168 | BASF | Antioxidant | | | | 1 | | 1 | 1 | | |
| | | (phosphorus-based) | | | | | | | | | |
| B-325 | Almorix | Aluminum hydroxide | 28 | | | | | | | | 70 |
| AA-18 | Sumitomo | Aluminum oxide | 20 | | 60 | 60 | 60 | 60 | 60 | 60 | |
| | Chemical | | | | | | | | | | |
| | Co., Ltd. | | | | | | | | | | |
| AA-3 | Sumitomo | Aluminum oxide | 4 | | 20 | 20 | 20 | 20 | 20 | 20 | |
| | Chemical | | | | | | | | | | |
| | Co., Ltd. | | | | | | | | | | |
| AA-03 | Sumitomo | Aluminum oxide | 0.4 | | 10 | 10 | 10 | 10 | 10 | 10 | |
| | Chemical | | | | | | | | | | |
| | Co., Ltd. | | | | | | | | | | |

| | | | | | | | |
|---|---|---|---|---|---|---|---|
| Viscosity Pa · s | 241 | 253 | 148 | 247 | 251 | 240 | 35 |
| Thermal conductivity W/m · K | 3.0 | 3.0 | 3.0 | 3.0 | 3.0 | 3.0 | 1.0 |

TABLE 4

| | | | Average | | | | | | | | | | | | | | | | | | |
|---|---|---|---|---|---|---|---|---|---|---|---|---|---|---|---|---|---|---|---|---|---|
| | | | particle | | Liq- | Liq- | Liq- | Liq- | Liq- | Liq- | Liq- | Liq- | Liq- | Liq- | Liq- | Liq- | Liq- | Liq- | Liq- | Liq- | Liq- |
| Material | Maker | Material | diameter | | uid | uid | uid | uid | uid | uid | uid | uid | uid | uid | uid | uid | uid | uid | uid | uid | uid |
| name | or agent | type | μm | pKa | B-17 | B-18 | B-19 | B-20 | B-21 | B-22 | B-23 | B-24 | B-25 | B-26 | B-27 | B-28 | B-29 | B-30 | B-31 | B-32 | B-33 |
| POLYVEST | Evonik | Hydroxyl | | | 3 | 3 | 3 | 3 | 3 | 3 | 3 | 3 | 3 | 3 | 3 | 3 | 3 | 3 | 3 | 3 | 3 |
| HT | | group- | | | | | | | | | | | | | | | | | | | |
| | | modified | | | | | | | | | | | | | | | | | | | |
| | | poly- | | | | | | | | | | | | | | | | | | | |
| | | butadiene | | | | | | | | | | | | | | | | | | | |
| Clearlink- | Dorf Ketal | Curing | | 11.5 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 |
| 1000 | | accelerator | | | | | | | | | | | | | | | | | | | |
| DISPERBYK- | BYK | Dispersing | | | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 |
| 145 | Chemie | agent | | | | | | | | | | | | | | | | | | | |
| | Co., Ltd. | | | | | | | | | | | | | | | | | | | | |
| BIOCIZER | Riken | Plasticizer | | | 5.3 | 4.1 | 4.1 | 4.1 | 4.1 | 4.1 | 4.1 | 4.1 | 4.1 | 4.1 | 4.1 | 4.1 | 4.1 | 4.1 | 4.1 | 4.1 | 2.9 |
| | Vitamin | | | | | | | | | | | | | | | | | | | | |
| Irganox | BASF | Antioxidant | | | | 1.2 | | | | | | | | | | 0.6 | 0.6 | 0.6 | | | |
| 1010 | | (phenol- | | | | | | | | | | | | | | | | | | | |
| | | based) | | | | | | | | | | | | | | | | | | | |
| Irganox | BASE | Antioxidant | | | | | 1.2 | | | | | | | | | | | | 0.6 | | |
| 1135 | | (phenol- | | | | | | | | | | | | | | | | | | | |
| | | based) | | | | | | | | | | | | | | | | | | | |
| Irganox | BASF | Antioxidant | | | | | | 1.2 | | | | | | | | | | | | 0.6 | |
| 1520L | | (phenol- | | | | | | | | | | | | | | | | | | | |
| | | based) | | | | | | | | | | | | | | | | | | | |
| Irgafos | BASF | Antioxidant | | | | | | | 1.2 | | | | | | | 0.6 | | | | | 1.2 |
| 168 | | (phosphorus- | | | | | | | | | | | | | | | | | | | |
| | | based) | | | | | | | | | | | | | | | | | | | |
| ADK | ADEKA | Antioxidant | | | | | | | | 1.2 | | | | | | | 0.6 | 0.3 | 0.6 | 0.6 | 1.2 |
| STAB | | (phosphorus- | | | | | | | | | | | | | | | | | | | |
| 1500 | | based) | | | | | | | | | | | | | | | | | | | |
| ADK | ADEKA | Antioxidant | | | | | | | | | 1.2 | | | | | | | 0.3 | | | |
| STAB | | (thiol-based) | | | | | | | | | | | | | | | | | | | |
| AO-503 | | | | | | | | | | | | | | | | | | | | | |
| DSTP | DKS | Antioxidant | | | | | | | | | | 1.2 | | | | | | | | | |
| | | (thiol-based) | | | | | | | | | | | | | | | | | | | |
| Irganox | BASF | Antioxidant | | | | | | | | | | | 1.2 | | | | | | | | |
| L57 | | (diphenyl- | | | | | | | | | | | | | | | | | | | |
| | | amine- | | | | | | | | | | | | | | | | | | | |
| | | based) | | | | | | | | | | | | | | | | | | | |
| Vitamin C | Fuso | Antioxidant | | | | | | | | | | | | 1.2 | | | | | | | |
| | chemical | (ascorbic | | | | | | | | | | | | | | | | | | | |
| | co., ltd. | acid-based) | | | | | | | | | | | | | | | | | | | |
| Tinuvin | BASF | Antioxidant | | | | | | | | | | | | | 1.2 | | | | | | |
| 770 DF | | (HALS) | | | | | | | | | | | | | | | | | | | |
| AZ35-125 | Nippon | Aluminum | 37 | | 60 | 60 | 60 | 60 | 60 | 60 | 60 | 60 | 60 | 60 | 60 | 60 | 60 | 60 | 60 | 60 | 60 |
| | Steel | oxide | | | | | | | | | | | | | | | | | | | |
| | Chemical | | | | | | | | | | | | | | | | | | | | |
| | & | | | | | | | | | | | | | | | | | | | | |
| | Material | | | | | | | | | | | | | | | | | | | | |
| | Co., Ltd. | | | | | | | | | | | | | | | | | | | | |
| AA-3 | Sumitomo | Aluminum | 4 | | 21 | 21 | 21 | 21 | 21 | 21 | 21 | 21 | 21 | 21 | 21 | 21 | 21 | 21 | 21 | 21 | 21 |
| | Chemical | oxide | | | | | | | | | | | | | | | | | | | |
| | Co., Ltd. | | | | | | | | | | | | | | | | | | | | |
| ASFP-20 | Denka | Aluminum | 0.3 | | 10 | 10 | 10 | 10 | 10 | 10 | 10 | 10 | 10 | 10 | 10 | 10 | 10 | 10 | 10 | 10 | 10 |
| | Co., Ltd. | oxide | | | | | | | | | | | | | | | | | | | |

| | | | | | | | | | | | | | | | | | |
|---|---|---|---|---|---|---|---|---|---|---|---|---|---|---|---|---|---|
| Viscosity Pa · s | 250 | 280 | 253 | 256 | 282 | 260 | 262 | 268 | 254 | 273 | 259 | 281 | 270 | 270 | 258 | 258 | 290 |
| Thermal conductivity W/m · K | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 | 3.2 |

The 8 types of the liquid A and 33 types of the liquid B which were obtained were examined regarding the presence or absence of changes in viscosity and properties after being stored at 60° C. for one month, but no viscosity changes or property changes exceeding ±20% were observed in either of the above.

### Example 1: Mixing of Liquid A-1 and Liquid B-3 and Production of Sheet

The liquid A-1 and the liquid B-3 were mixed at a volume ratio of 1:1 by filling the liquid A-1 and the liquid B-3 in each of the 100 ml tanks provided on both sides of a 200 ml two-liquid parallel cartridge manufactured by Nordson and passing the liquids through a 24-stage disposable spiral mixer (static mixer).

By coating the obtained mixed liquid on a glass plate and pushing the mixed liquid down using an aluminum plate with 1 mm thick spacers installed at both ends, a sheet having a thickness of 1 mm with the mixed liquid AB sandwiched between the glass plate and the aluminum plate was produced.

With the same operation as in Example 1, the liquid A and the liquid B were mixed in accordance with the blends in Table 5 and Table 6 to obtain the mixed liquids AB and sheets of Examples 1 to 24 and Comparative Examples 1 to 4.

The mixed liquids AB and sheets obtained in Examples 1 to 24 and Comparative Examples 1 to 4 were subjected to tests for the items listed in Table 5 and Table 6 (thermal conductance, hardness, initial curing time, complete curing time, a thermal impact test, and an aging test) and the results as in Table 5 and Table 6 were obtained. Viscosity and thermal conductance tests were conducted for each of the liquid A and the liquid B and the results are listed in Tables 1 to 4.

TABLE 5

| | | Ex- | Ex- | Ex- | Ex- | Ex- | Ex- | Ex- | Ex- | Ex- | Com- | Com- | Com- |
|---|---|---|---|---|---|---|---|---|---|---|---|---|---|
| | | ample | ample | ample | ample | ample | ample | ample | ample | ample | parative | parative | parative |
| | | 1 | 2 | 3 | 4 | 5 | 6 | 7 | 8 | 9 | Example 1 | Example 2 | Example 3 |
| Liquid A | | A-1 | A-2 | A-3 | A-2 | A-5 | A-6 | A-5 | A-4 | A-7 | A-1 | A-4 | A-4 |
| Liquid B | | B-3 | B-2 | B-1 | B-3 | B-11 | B-12 | B-13 | B-14 | B-16 | B-1 | B-10 | B-15 |
| Thermal conductivity W/m · K | | 2.5 | 2.9 | 2.9 | 2.5 | 3.0 | 3.0 | 3.0 | 3.0 | 1.0 | 2.9 | 3.0 | |
| Hardness (Shore OO) | | 52 | 49 | 50 | 51 | 65 | 66 | 52 | 46 | 48 | 53 | 65 | Not cured |
| Hardness (Shore O) | | 21 | 20 | 21 | 21 | 33 | 34 | 22 | 15 | 17 | 22 | 34 | |
| Initial curing time min | | 30 | 5 | 5 | 30 | 30 | 30 | 30 | 20 | 5 | 5 | 30 | |
| Complete curing time days | | 3 | 1 | 1 | 3 | 2 | 2 | 3 | 2 | 1 | 1 | 2 | |
| Thermal impact test | Cracking and peeling | A | B | B | A | A | A | A | A | A | B | C | |
| Aging test | Cracking and peeling | A | B | B | A | A | A | A | A | A | B | C | |
| | Brittleness 1 | A | B | B | A | A | A | A | A | A | C | C | |
| | Brittleness 2 | B | B | B | A | A | A | A | C | A | C | C | |
| | Comprehensive | A | BB | BB | AA | AA | AA | AA | B | AA | C | C | |
| | Evaluation of | | | | | | | | | | | | |
| | Brittleness | | | | | | | | | | | | |

TABLE 6

| | | | | | | | | | | | | | | | | | Com- |
|---|---|---|---|---|---|---|---|---|---|---|---|---|---|---|---|---|---|
| | | Ex- | Ex- | Ex- | Ex- | Ex- | Ex- | Ex- | Ex- | Ex- | Ex- | Ex- | Ex- | Ex- | Ex- | Ex- | parative |
| | | ample | ample | ample | ample | ample | ample | ample | ample | ample | ample | ample | ample | ample | ample | ample | Example |
| | | 10 | 11 | 12 | 13 | 14 | 15 | 16 | 17 | 18 | 19 | 20 | 21 | 22 | 23 | 24 | 4 |
| Liquid A | | A-8 | A-8 | A-8 | A-8 | A-8 | A-8 | A-8 | A-8 | A-8 | A-8 | A-8 | A-8 | A-8 | A-8 | A-8 | A-8 |
| Liquid B | | B-18 | B-19 | B-20 | B-28 | B-29 | B-30 | B-31 | B-32 | B-33 | B-21 | B-22 | B-23 | B-24 | B-25 | B-27 | B-17 |
| Thermal conductivity W/m · K | | 3.4 | 3.4 | 3.4 | 3.4 | 3.4 | 3.4 | 3.4 | 3.4 | 3.4 | 3.4 | 3.4 | 3.4 | 3.4 | 3.4 | 3.4 | 3.4 |
| Hardness (Shore OO) | | 68 | 64 | 63 | 68 | 66 | 68 | 67 | 61 | 60 | 68 | 66 | 68 | 69 | 67 | 66 | 70 |
| Hardness (Shore O) | | 38 | 34 | 33 | 38 | 36 | 38 | 37 | 31 | 30 | 38 | 36 | 38 | 39 | 37 | 36 | 40 |
| Initial curing time min | | 60 | 60 | 60 | 60 | 60 | 60 | 60 | 60 | 60 | 60 | 60 | 60 | 60 | 60 | 60 | 60 |
| Complete curing time days | | 2 | 2 | 2 | 2 | 2 | 2 | 2 | 2 | 2 | 2 | 2 | 2 | 2 | 2 | 2 | 2 |
| Thermal | Cracking and peeling | A | A | A | A | A | A | A | A | A | A | A | A | A | A | A | B |
| impact test | | | | | | | | | | | | | | | | | |
| Aging test | Cracking and peeling | A | A | A | A | A | A | A | A | A | A | A | A | A | A | A | B |
| | Brittleness 1 | A | A | A | A | A | A | A | A | A | A | A | B | B | A | A | C |
| | Brittleness 2 | A | A | A | B | B | B | B | A | A | C | C | C | C | C | C | C |
| | Comprehensive | AA | AA | AA | A | A | A | A | AA | AA | B | B | B | B | B | B | C |
| | Evaluation of | | | | | | | | | | | | | | | | |
| | Brittleness | | | | | | | | | | | | | | | | |

### “Viscosity”

Measurement was performed using a rheometer MCR302, PP25 manufactured by Anton Paar, at a measurement temperature of 23° C. and a shear rate of 1 (1/s).

### “Thermal Conductance”

Measurement was performed using a TIM tester manufactured by LINSEIS in accordance with ASTM D5470. In Examples 1 to 24 and Comparative Examples 1 to 4, the samples for thermal conductance measurement were samples obtained by curing the sheets described above. The sheets were cured under the conditions of curing temperature: 25° C., and curing time: complete curing time as in Table 5 and Table 6.

### “Hardness”

Measurement was performed using a Shore OO type durometer (manufactured by Teclock Co., Ltd., product name: Teclock Durometer GS-754G) and a Shore 0 type durometer (manufactured by Teclock Co., Ltd., product name: Teclock Durometer GS-753G), in accordance with ASTM D2240. In Examples 1 to 24 and Comparative Examples 1 to 4, the samples for hardness measurement were obtained by curing the sheet described above. The sheets were cured under conditions of curing temperature: 25° C., curing time: complete curing time as in Table 5 and Table 6.

### “Initial Curing Time”

The time required for the viscosity of the mixed liquid AB at 23° C. to double from the initial viscosity after mixing was set as the time.

### “Complete Curing Time”

When the mixed liquids AB obtained in Examples and Comparative Examples were left at 23° C., the time (number of days) until the hardness thereof became constant was measured.

### “Thermal Impact Test”

The sheets obtained in Examples and Comparative Examples were subjected to 2000 cycles in which one cycle involves being held at −40° C. for 20 minutes, heated to 100° C. in 10 minutes, held for 20 minutes, and cooled to −40° C. in 10 minutes for a total of 60 minutes, after which the degree of cracking and peeling was evaluated in accordance with the following indices.
A (Very good): No cracking or peeling
B (Good): Only one of cracking or peeling is observed
C (Poor): Both cracking and peeling are observed

### “Aging Test: Cracking and Peeling”

After the sheets obtained in the Examples and the Comparative Examples were left in an oven at 100° C. for 2000 hours, the degree of cracking and peeling was visually observed and evaluated in accordance with the following indices.
A (Very good): No cracking or peeling
B (Good): Only one of cracking or peeling is observed
C (Poor): Both cracking and peeling are observed

### “Aging Test: Brittleness”

### <Brittleness 1>

The hardness after the aging test was measured using the same method as for the “Hardness” above and the brittleness 1 was evaluated in accordance with the following indices. It was confirmed that when the hardness is 85 or more on the Shore OO scale, the material becomes harder and thus shows a tendency to crack when bent, and when the hardness exceeds 90 on the Shore OO scale or 70 on the Shore 0 scale, the material is excessively hard and cracks when bent in most cases.
A (Very good): Less than 85 in Shore OO
B (Good): 85 or more in Shore OO
C (Poor): Over 90 in Shore OO or over 70 in Shore 0

### <Brittleness 2>

In the method for producing the sheets of the Examples and the Comparative Examples, the thickness of the spacers was changed to 3 mm to produce a sheet having a thickness of 3 mm with the mixed liquid AB sandwiched therein. The hardness of the sheet having a thickness of 3 mm with the mixed liquid AB sandwiched therein was measured using the same method as for the “Hardness” described above. During the hardness measurement, the location where the indentor of the hardness meter (the geometry of the indentor: hemispherical, tip R 1.19 mm) was inserted was observed under an optical microscope at 40 times magnification. Brittleness 2 is a brittleness evaluation standard that is a stricter standard than brittleness 1.

Brittleness 2 was evaluated in accordance with the following indices.
A (Very good): A soft and dented state in which there are no cracks on the surface
B (Good): A state in which a few cracks are seen on the surface, but it is possible to repair the cracks by pressing
C (Poor): A state in which cracks are seen on the surface

### <Comprehensive Evaluation of Brittleness>

The brittleness was comprehensively evaluated in accordance with the following indices.
AA (Best): The evaluation of both brittleness 1 and brittleness 2 is A
A (Very good): The evaluation of brittleness 1 is A and evaluation of brittleness 2 is B
BB (Better): The evaluation of brittleness 1 is B and the evaluation of brittleness 2 is B
B (Good): The evaluation of brittleness 1 is A or B and the evaluation of brittleness 2 is C
C (Poor): The evaluation of brittleness 1 and brittleness 2 is C

From the above, in the Examples, the evaluation of cracking and peeling after the thermal impact test and the evaluation of cracking/peeling and brittleness after the aging test were both better than for the Comparative Examples. That is, according to the resin composition for a heat-dissipating gap filler of the present embodiment, it is possible to reduce the occurrence of cracking and peeling even when the heat-dissipating gap filler is exposed to high temperature conditions for a long time or undergoes rapid temperature changes.

In addition, it is possible to maintain an appropriate hardness under conditions corresponding to actual use situations.

Furthermore, it was understood that the two liquid-type heat-dissipating gap filler resin composition has good storage stability before mixing the liquid A and the liquid B and has good operability after mixing due to having an appropriate room temperature curing property with an initial curing time of 5 to 60 minutes at room temperature.

The resin composition for a heat-dissipating gap filler of the present embodiment does not need to contain volatile silicone or low molecular siloxane, which can cause contact failure, and voids are not generated by water or gas present in the system or produced by the curing reaction.

This application claims priority based on Japanese Patent Application No. 2021-163412 filed on Oct. 4, 2021 and Japanese Patent Application No. 2022-072233 filed on Apr. 26, 2022, the entire disclosure of which is incorporated herein.

1. A resin composition for a heat-dissipating gap filler comprising:
a maleic anhydride-modified polybutadiene;
a hydroxyl group-modified polybutadiene;
a thermally conductive filler; and
an antioxidant,
wherein a content of the antioxidant is 0.01% by mass or more when a total amount of the resin composition for a heat-dissipating gap filler is 100% by mass, and
a thermal conductance of the resin composition for a heat-dissipating gap filler after curing is 1.0 W/m·K or more.

2. The resin composition for a heat-dissipating gap filler according to claim 1,
wherein a content of the thermally conductive filler is 70% by mass or more when the total amount of the resin composition for a heat-dissipating gap filler is 100% by mass.

3. The resin composition for a heat-dissipating gap filler according to claim 1laim-1-er-2
wherein the antioxidant includes at least one type selected from the group consisting of a phenol-based antioxidant and a phosphorus-based antioxidant.

4. The resin composition for a heat-dissipating gap filler according to claim 3,
wherein the antioxidant includes a phenol-based antioxidant.

5. The resin composition for a heat-dissipating gap filler according to claim 1, further comprising:
a curing accelerator.

6. The resin composition for a heat-dissipating gap filler according to claim 5,
wherein the curing accelerator includes an amine-based curing accelerator.

7. The resin composition for a heat-dissipating gap filler according to claim 6,
wherein a pKa of the amine-based curing accelerator is 8.0 or more.

8. The resin composition for a heat-dissipating gap filler according to claim 1,
wherein the resin composition for a heat-dissipating gap filler is a two liquid-type resin composition for a heat-dissipating gap filler.

9. The resin composition for a heat-dissipating gap filler according to claim 8, further comprising:
a liquid A including the maleic anhydride-modified polybutadiene and the thermally conductive filler; and
a liquid B including the hydroxyl group-modified polybutadiene and the thermally conductive filler.

10. A heat-dissipating gap filler obtained by curing the resin composition for a heat-dissipating gap filler according to claim 1.

11. An article comprising:
the heat-dissipating gap filler according to claim 10.
